(19) United States
(12) Patent Application Publication
(10) Pub. No.: US 2008/0019354 A1
(43) Pub. Date: Jan. 24, 2008

(54) Auto-hunting system for group-collective VoIP number and the method of the same

(75) Inventor: Yun-Lung Wan, Taipei (TW)

Correspondence Address: BACON & THOMAS, PLLC, 625 SLATERS LANE, FOURTH FLOOR, ALEXANDRIA, VA, 22314, US

(73) Assignee: InfoAction Technology, Inc., Taipei (TW)

(21) Appl. No.: 11/730,235

(22) Filed: Mar. 30, 2007

(30) Foreign Application Priority Data
Mar. 30, 2006 (TW) 095111335

(51) Int. Cl. H04L 12/66

(52) U.S. Cl. 370/352

(57) ABSTRACT

The present invention discloses an auto-hunting system for group-collective VoIP number VoIP. The system includes an operator r module, VoIP gateway, RJ11, PRI or BRI, private branch exchange (PBX), and an extension device. The above-mentioned operator module may be the software or merely a set of computer-executable instructions stored in the server or in the VoIP gateway. The operator module may contain a plurality of lines. Each line within the operator module would be connected to one specific VoIP phone number, an identification (account) of VoIP applications, or an Internet protocol address. According to interconnect the IP network and the PBX system, the VoIP gateway converts between analog voice signal and IP information packets. RJ11, PRI, BRI is used to connect PBX and the extension device.

### FIELD OF THE INVENTION

The present invention relates generally to VoIP (Voice over IP), and more particularly to a method and a system for operating of VoIP phone number dialing.

### BACKGROUND OF THE INVENTION

Retrospect to technology history of 90's, the Internet is to be regarded as a significant development, and the influence of the Internet on people's life is self-evident. Nowadays, because of the sharing feature of the Internet, people don't have to go to a physical place or meet someone personally for obtaining and exchanging information.

Exchanging information is the primitive purpose of the Internet development. Originally, people on Internet interchange messages by means of a mail, a bbs (Bulletin Board System) or a website board. The demand of users accompanying with the Internet growth is a more instant and convenient method or device for communication. Many instant message (IM) applications have been developed, which includes, but not limited to, ICQ™, MSN™, Jabber™. Soon after that, VoIP (Voice over IP) technology, like Skype™, comes up. VoIP sends and receives calls in an instant way by the usage of an adapter to convert voice signals into data packets for Internet transmission. VoIP technology has the potential to provide increased communication flexibility and much cheaper phone service. Especially, VoIP technology is provided to reduce service fees for international phone service; therefore more and more enterprises adopt VoIP technology. However, VoIP is not ripe enough for the habits of commerce in some respects. One such problem is that a firm would provide representative IP phone numbers. However, one firm usually has a few IP phone numbers, and each IP phone number would be connected to one specific line owned to deal the number. Under such situation, a caller who wants to connect to a firm may dial a busy line number, and then dial and try another phone number until the caller meets a free line. The present invention addresses such problems to provide a novel method and system for operating VoIP phone number dialing.

### SUMMARY OF THE INVENTION

According to solve the aforementioned weakness, the present invention offers a more convenient way for a VoIP caller. With the more convenient way, any caller could simply ring up an extension through VoIP phone by means of following the message suggested by a system of the present invention. Previous to the present invention, provided that a VoIP caller dials a number, an IP protocol address, or an account of Internet communication applications with a busy line, the caller should have to try another phone number, another IP protocol address, or another account of Internet communications applications randomly and continuously until he meets a free line. The present invention hunts a free line instead of finding by a caller himself.

For the purpose of the present invention, a system for operating phone number dialing is disclosed. The system for operating number dialing contains an operator module, VoIP gateway, RJ11, private branch exchange (PBX), an extension device. The above-mentioned operator module may be the software or merely a set of computer-executable instructions stored in a server or in a VoIP gateway. And the operator module may contain many lines. Each line within the operator module would be connected to one specific VoIP phone number, one IP protocol address, or one account of Internet communication applications According to connecting the IP network and the network of the system, the VoIP gateway converts between analog voice signal and IP information packets. RJ11 is used to connect PBX and the extension device. Additionally, the present invention permits the extension as a client terminal to connect the PBX of the system for calling someone up. For example, the extension as the client terminal may be as a staff of an office with the system. And the staff could call someone up via the extension connecting the PBX of the system. And the PBX would instruct the operator module that one line is taken up by the client terminal device until the extension hangs up.

In accordance with another aspect of the present invention, there is provided a method for the system to operate VoIP phone dialing. When a caller dials a VoIP phone number, an IP protocol address, or an account of Internet communication belongs to the system, the caller terminal connects to the operator module. Since each VoIP phone number, each IP protocol address, or each account of Internet communications applications referred to one specific line, the operator module would check that the line dialed by the caller is free or busy. Provided that the caller dials a busy line, the operator module would find another free line and send a suggestive message to tell the caller which line is free and hold the free line for the caller. Then the caller accepts the message and connects the line proposed by the operator module.

Detailed description of the present invention will be expressed by the following description of a preferred embodiment taken together with the accompanying drawings and the appended claims.

### BRIEF DESCRIPTION OF THE DRAWINGS

FIG. 1 is the block diagram of first embodiment according to the present invention.

FIG. 2 is the block diagram of second embodiment according to the present invention.

FIG. 3 is the flow chart of the method according to third embodiment of the present invention.

FIG. 4 is the flow chart of the method according to fourth embodiment of the present invention.

### DETAILED DESCRIPTION OF THE PREFERRED EMBODIMENT

The present invention is described with the preferred embodiments and accompanying drawings. It should be appreciated that all the embodiments are merely used for illustration. Hence, the present invention can also be applied to various embodiments other than the preferred embodiments. Besides, the present invention is not limited to any embodiment but to the appending claims and their equivalents.

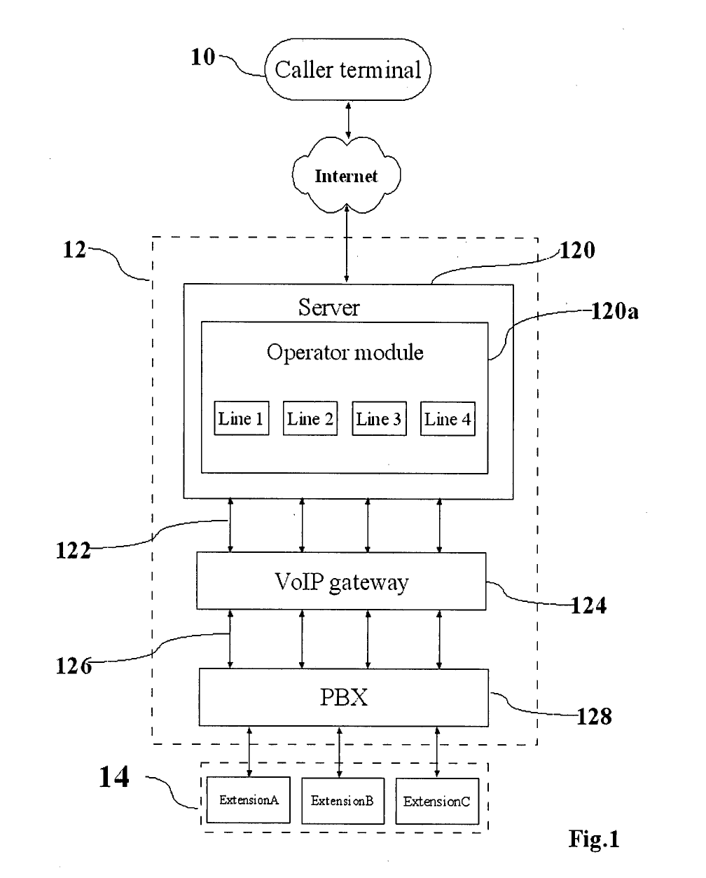

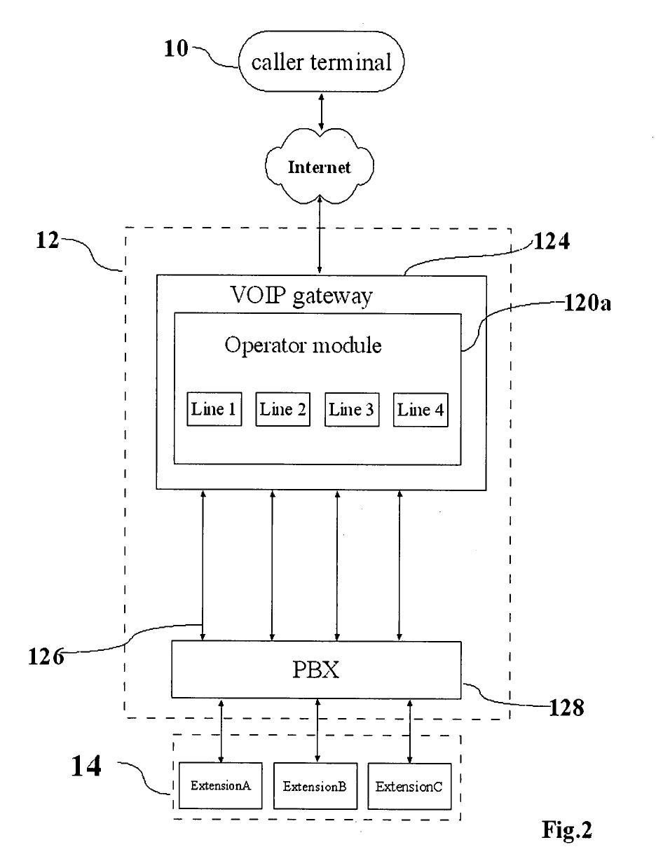

FIG. 1 and FIG. 2 represent the preferred embodiments of the present invention.

FIG. 1 and FIG. 2 both have: a caller terminal 10, a system 12, an extension device 14.

The caller terminal 10 expresses an unspecified caller who wants to connect an extension of the extension device 14 by means of dialing VoIP phone number, an IP address, or an account of Internet communication applications, wherein the extension device 14 has at least one extension. For instance, extension A-C in FIG. 1 or FIG. 2, but not limited to only three extensions. The system 12 used for operating VoIP process includes an operator module 120a. The operator module 120a be the software or merely a set of computer-executable instructions stored in the server 120 or in the VoIP gateway 124. FIG. 1 represents the operator module 120a establishes within the server 120. And FIG. 2 represents the operator module 120a establishes within the VoIP gateway 124.

Please refer to FIG. 1, the system 12 further contains IEEE1394 or PCI or USB 122, VoIP gateway 124, RJ11 or PRI or BRI 126, and PBX 128.

Moreover, the control module 120a may contain many lines, for instance, line1˜line4 in FIG. 1, but not limited to only four lines. And one VoIP phone number, one IP protocol address, or one account of Internet communication applications connects to one specific line.

When dialing a VoIP phone number, an IP protocol address, or an account of Internet communication applications belongs to the operator module 120a, the caller terminal 10 connects to the server 120. Since each VoIP phone number referred to one specific line, the operator module 120a would check which line is free and put the caller terminal 10 through to the free line. For the most part, there are two situations. One situation is that the caller dials a VoIP phone number and the line corresponding to the VoIP phone number is free. Then the operator module 120a would establish connecting between the caller terminal 10 and the free line. Then the caller may contact with an extension of the extension device 14 through the free line. Another situation is that the caller dials a VoIP phone number, an IP protocol address, or an account of Internet communication applications with a busy line. Then the operator module 120a would hunt a free line. If another line is free, the operator module 120a will send a suggestive message to tell the caller which line is free and hold the free line for the caller terminal 10. Assuming that no free line exits, the operator module 120a would propose the caller may call later.

For those who are skilled in the art, the server 120 connects VoIP gateway 124 by IEEE134 or PCI or USB 122 and the VoIP gateway 124 connects private branch exchange (PBX) 128 by RJ11 or PRI or BRI 126. The VoIP gateway 124 interconnects the IP network and the network within the system 12 via converting between analog voice signal and IP information packets. For example, but not limited to Infoaction Technology, Inc. of Taiwan produces the VoIP gateway named VOSKY 9000™ or Actiontec Electronics, Inc. of USA produces the product named VoSKY™ Exchange. And the functions of PBX 128 may include, but not limit to, automatic attendant (AA), holding a call or transferring a call. The caller could input an extension number to PBX 128 for interconnecting an extension of the extension device 14.

Additionally, in one embodiment of the present invention, it allows an extension of the extension device 14 to connect the PBX 128 for calling someone up. For example, the extension A of the extension device 14 may express a client terminal of an office with the system 12. And the client terminal could call someone up via the extension A that is connected to the PBX 128 of the system 12. The PBX 128 hunts and provides a free line. Then the client terminal could interconnect another one through the free line. And the PBX 128 would instruct the operator module 120a that this free line is taken up by the client terminal until the extension A hangs up.

Please refer to FIG. 2, the system 12 further contains VoIP gateway 124, RJ11 or PRI or BRI 126, and PBX 128. And the operator module 120a is established within the VoIP gateway.

Moreover, the control module 120a may contain many lines, for instance, line1˜line4 in FIG. 1, but not limited to only four lines. And one VoIP phone number, one IP protocol address, or one account of Internet communication applications connects to one specific line.

When Dialing a VoIP phone number, an IP protocol address, or an account of Internet communication applications belongs to the operator module 120a, the caller terminal 10 connects to the VoIP gateway 124. Since each VoIP phone number referred to one specific line, the operator module 120a would check which line is free and put the caller terminal 10 through to the free line. For the most part, there are two situations. One situation is that the caller dials a VoIP phone number and the line corresponding to the VoIP phone number is free. Then the operator module 120a would establish connecting between the caller terminal 10 and the free line. Then the caller may contact with an extension of the extension device 14 through the free line. Another situation is that the caller dials a VoIP phone number, an IP protocol address, or an account of Internet communication applications with a busy line. Then the operator module 120a would hunt a free line. If another line is free, the operator module 120a will send a suggestive message to tell the caller which line is free and hold the free line for the caller terminal 10. Assuming that no free line exits, the operator module 120a would propose the caller may call later.

For those who are skilled in the art, the VoIP gateway 124 connects private branch exchange (PBX) 128 by PJ11 or PRI or BRI 126. The VoIP gateway 124 interconnects the IP network and the network within the system 12 via converting between analog voice signal and IP information packets. For example, but not limited to Infoaction Technology, Inc. of Taiwan produces the VoIP gateway named VoSKY 9000™ or Actiontec Electronics, Inc. of USA produces the product named VoSKY™ Exchange. And the functions of PBX 128 may include, but not limit to, automatic attendant (AA), holding a call or transferring a call. The caller could input an extension number to PBX 128 for interconnecting an extension of the extension device 14.

Additionally, in one embodiment of the present invention, it allows an extension of the extension device 14 to connect the PBX 128 for calling someone up. For example, the extension A of the extension device 14 may express a client terminal of an office with the system 12. And the client terminal could call someone up via the extension A that is connected to the PBX 128 of the system 12. The PBX 128 hunts and provides a free line. T hen the client terminal could interconnect another one through the free line. And the PBX 128 would instruct the operator module 120a that this free line is taken up by the client terminal until the extension A hangs up.

According to the other aspect of the present invention, disclosing two flow charts. One is about the call flow in the system 12 and the other is about the call flow of the caller terminal 10.

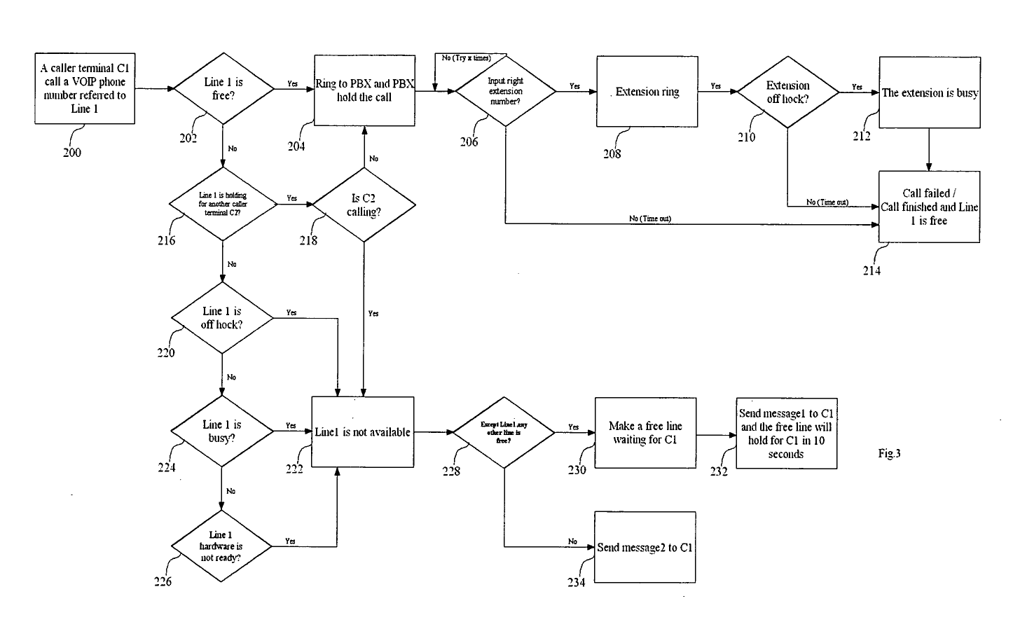

FIG. 3 shows a flow chart expresses that when a caller dials a VoIP phone number, an IP protocol address, or an account of Internet communication applications belongs to the system 12 stated above, the system 12 how to work.

Initially, a user may dial a call via a caller terminal C1 by a VoIP phone number referred to line 1 within the system 12 with an operator module in step 200, and the operator module as the above-mentioned operator module 120a. The operator module may be the software or merely a set of computer-executable instructions stored in the server or in the VoIP gateway. After the calling of the caller terminal C1, control is passed to the operator module for distinguishing line1 is free or not in step 202.

Hypothesize that line1 is free, in step 204, the caller terminal C1 connects to PBX through line1. And PBX would ask continuously unless the caller terminal C1 inputs a right extension number in step 206. Providing that C1 inputs and tries too much times, the connection between C1 and line1 will be broken. Thus the calling of C1 is failed and line1 is free in step 214. Supposing C1 inputs an extension number correctly, the extension that C1 wants to interconnect will ring in step 208. Then in step 210, if the extension is off hock (the extension is on another line), the extension sends a busy signal to line1 in step 212. Then the operator module would deal this busy signal and pass a message on to the caller terminal C1. C1 would get the message stated that the extension is busy and C1 may decide to wait for the extension or not. On the contrary, the extension is not off hock in step 210. After a period of time, the calling of the caller terminal C1 would be finished. However the calling is finished or failed, line1 would be free lastly in step 214.

If the determination in step 216 indicates that line1 is not free, then the operator module will verify whether line1 is already holding for another caller terminal C2.

Assuming that line1 is already holding for another caller terminal C2, the system will check whether C2 is calling on line1 or not in step 218. If the determination is positive, it means that another caller terminal C2 is on line1 exactly, the operator module knows that line1 1 is not available for C1 in step 222. Contrariwise, if another caller terminal C2 is not calling on line1 in step 218, line1 is free for C1. Then the caller terminal C1 can connect to PBX through line 1 in step 204.

In step 216, hypothesize that Line1 is not holding for another caller terminal, the operator module distinguishes whether line1 is off hock in step 220. The word “off hock” herein refers to a terminal as the above-mentioned client terminal 16 interconnecting another one through line1. Consequentially, line 1 is not available for the caller terminal C1 in step 222 while line1 is off hock. Otherwise, the operator module checks line1 is busy or not in step 224. The word “busy” herein means another caller keeps calling on line1. In other words, line1 is not free or available at the moment. Accordingly, assuming line1 is busy, step 222 is the result.

In step 224, if line1 is not in busy mode, the operator module verifies whether the hardware is ready in step 226. And the not ready hardware would lead to the situation of step 222.

Step 222, unavailable line1 for the caller terminal C1, results in step 228. Step 228 is hunting which line is free except line1. Assuming that a free line exists, the operator module makes the free line waiting for the caller terminal C1 in step 230. Then in step 232, the caller terminal C1 would be sent message1 by the operator module, and the free line would be held for C1 about 10 seconds of response time. It will be appreciated that the operator module sends message1 to C1 for the purpose of telling C1 which line is free. Provided that the caller terminal C1 accepts the suggestion of message1, the suggestive line will be connected to C1.

Assuming that there are no free lines, the operator module sends message2 to C1. The purpose of message2 is to tell the caller terminal C1 that all the lines are busy and C1 may ring up later.

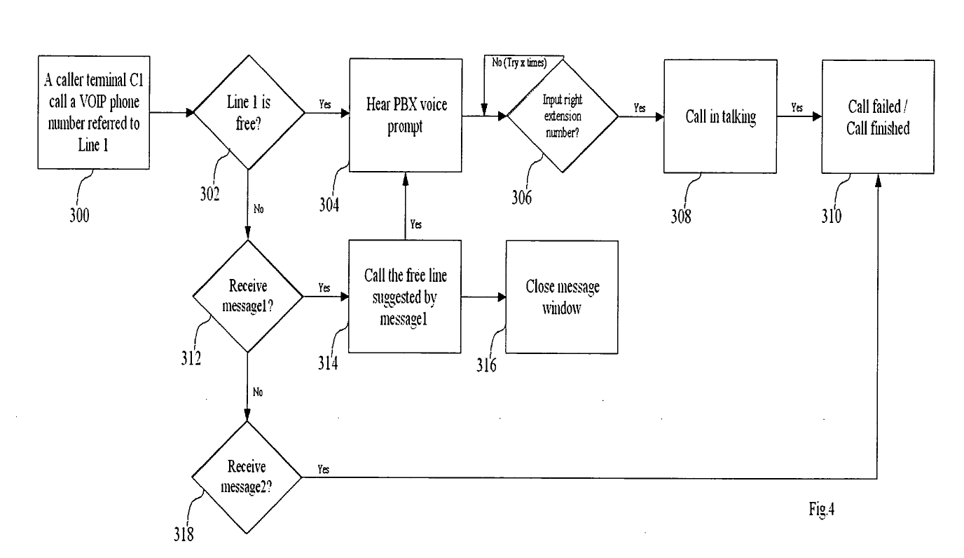

FIG. 4 shows a flow chart expresses that when a caller dials a VoIP phone number, an IP protocol address, or an account of Internet communication applications belongs to the system 12 stated above, the course of the caller terminal how to proceed.

A call is made via a caller terminal C1 to call a VoIP phone number referred to line 1 of the system 12 with an operator module in step 300, and the operator module as the above-mentioned operator module 120a. The operator module may be the software or merely a set of computer-executable instructions stored in the server or in the VoIP gateway. After the calling of the caller terminal C1, control is passed to the operator module for distinguishing line1 is free or not in step 302. Assuming that line1 is free, control is passed to PBX in step 304. PBX would give a prompt to the caller terminal C1 about the information of the extensions. And PBX would check whether the extension number input by C1 is correct in step 306. The caller terminal C1 connects to the extension in step 308 until C1 input the right extension number. After a period of time, the calling of the caller terminal C1 would be finished in step 310.

Provided that line1 is not free, message1 or message2 may be sent alternatively. The next step 312 is to verify whether the caller terminal C1 receives message1 or not. Receiving message1 means that a free line exists. And message1 would tell C1 which line is free. Thus, the caller terminal C1 connects to the free line suggested by message1 in step 314. Then C1 may interconnect with PBX via the free line in step 304. After connecting to the free line in step 314, the caller terminal may close the window of message1 in step 316.

Assuming the caller terminal C1 does not receive message1, message2 is sent to C1. Message2 means that all the lines are busy and the caller may call later. Thus, the calling of the caller terminal C1 is failed in step 310.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

We claim:

1. An auto-hunting system for group-collective VoIP number comprising:
an operator module for operating the VoIP communicating procedure of said system;
a VoIP gateway for interconnecting a IP network and a network within said system by means of converting between analog voice signal and IP information packets;
a private branch exchange (PBX) coupled to said VoIP gateway; and
at least one extension device coupled to said private branch exchange (PBX).

2. The system of claim 1, wherein said VoIP gateway includes said operator module.

3. The system of claim 1, further comprising a server coupled to Internet, wherein said server include said operator module.

4. The system of claim 3, wherein said VoIP gateway is coupled to said server.

5. The system of claim 1, wherein said control module further includes a plurality of lines, and one VoIP phone number, one IP address, or one account of Internet communication applications connected to one specific line of said plurality of lines.

6. The system of claim 5, wherein said control module further establishes connecting between a caller terminal and a free line when said caller terminal dials a VoIP phone number, an IP protocol address, or an account of Internet communication applications with said free line.

7. The system of claim 5, wherein said operator module further hunts and provides another free line for a caller terminal when said caller terminal dials a VoIP phone number, an IP protocol address, or an account of Internet communication applications with a line not free (a buy line).

8. The system of claim 5, wherein said operator module further proposes a caller terminal call later when said operator module finds out all lines are busy.

9. The system of claim 5, wherein said extension device calls someone up, wherein said PBX hunts and provides a free line for said extension device and said PBX would instruct said operator module that said free line is taken up by said extension device until said extension device hangs up.

10. A method for operating VoIP calling, comprising:
providing an operator module for operating the VoIP communicating procedure; and
providing a plurality of lines controlled by said operator module, and one VoIP phone number, one IP address, or one account of Internet communication applications connects to one specific of said plurality of lines.

11. The method of claim 10, further comprising:
calling a VoIP phone number, an IP protocol address, or an account of Internet communication applications belongs to said controller module by a caller terminal;
checking by said operator module whether a line referred to said VoIP phone number, said IP protocol address, or said account of Internet communication applications dialed by said caller terminal is free; and
if said operator module finds that said line referred to said VoIP phone number, said IP protocol address, or said account of Internet communication applications dialed by said caller terminal is free, then said operator module will establish connecting between said caller terminal and said free line.

12. The method of claim 11, further comprising:
if said operator module finds that said line referred to said VoIP phone number, said IP protocol address, or account of Internet communication applications dialed by said caller terminal is busy (not free), then said operator module will hunt and provide another free line for said caller terminal;
if said operator module finds another free line is existent, said operator module will connect between said caller terminal and said free line;
if said operator module finds out all lines are busy, said operator module will propose said caller terminal could call later.
